(19) United States
(12) Patent Application Publication
(10) Pub. No.: US 2025/0334938 A1
(43) Pub. Date: Oct. 30, 2025

(54) INTELLIGENT WATER PRECISE IRRIGATION CONTROL SYSTEM AND METHOD FOR CULTIVATION OF FRUIT VEGETABLES IN SOLAR GREENHOUSES

(71) Applicant: INSTITUTE OF VEGETABLES AND FLOWERS, CHINESE ACADEMY OF AGRICULTURAL SCIENCES, Beijing (CN)

(72) Inventors: Jun WANG, Beijing (CN); Yansu LI, Beijing (CN); Xianchang YU, Beijing (CN); Wei LU, Beijing (CN); Quan YUAN, Beijing (CN); Ru CHEN, Beijing (CN); Mintao SUN, Beijing (CN); Chaoxing HE, Beijing (CN); Yan YAN, Beijing (CN)

(73) Assignee: INSTITUTE OF VEGETABLES AND FLOWERS, CHINESE ACADEMY OF AGRICULTURAL SCIENCES, Beijing (CN)

(21) Appl. No.: 18/867,468

(22) PCT Filed: May 25, 2022
(86) PCT No.: PCT/CN2022/094818

§ 371 Date: Nov. 20, 2024

(30) Foreign Application Priority Data
Jun. 1, 2021 (CN) 202110607031.3
Sep. 6, 2021 (CN) 202111041109.6

(51) Int. Cl. A01G 9/24; A01G 25/16; G05B 13/02

(52) U.S. Cl. CPC G05B 13/027

(57) ABSTRACT

The present disclosure relates to an intelligent water precise irrigation control system and method for cultivation of fruit vegetables in solar greenhouses. The system includes: an information acquisition module for acquiring information by means of sensors, the acquired information including at least one of soil information, ground environment information, irrigation device use process information, and crop information; a water demand prediction module for inputting the acquired information into a deep neural network to predict water demand of fruit vegetables; and an irrigation control module for forming a control instruction according to the predicted water demand, so as to irrigate periodically and quantitatively. In this way, irrigation time and irrigation amount can be decided automatically according to growth conditions and environmental parameters in the whole process. Intelligent irrigation can be achieved with high working efficiency and accuracy, and the water-saving, quality-improved and efficiency-improved production of fruit vegetables can be achieved.

### TECHNICAL FIELD OF THE INVENTION

The present disclosure relates to the technical field of crop irrigation, and in particular to an intelligent water precise irrigation control system and method for cultivation of fruit vegetables in solar greenhouses. The present disclosure claims priority to the Application No. CN202110607031.3 filed with the CNIPA on Jun. 1, 2021 and the Application No. CN202111041109.6 filed with the CNIPA on Sep. 6, 2021, the entire disclosures of which are incorporated herein by reference.

### BACKGROUND OF THE INVENTION

The area of protected facilities in China has reached 28.4 million mu (approximately 1.89 million hectares), with solar greenhouses accounting for approximately 31%. The main types of fruit vegetables cultivated in these facilities include chili pepper, tomato, cucumber, eggplant, etc. Off-season cultivation in protected facilities has become an important part of people's daily supply of fruit vegetables. However, in the actual production process, producers often rely on experience for extensive irrigation, which causes waste of water resources and reduces the utilization efficiency of fertilizer resources and fruit quality. Therefore, it is particularly important to realize precise irrigation based on the law of water demand of fruit vegetables and the external environment for saving water and improving quality.

The Chinese patent document CN 109845625 A discloses an intelligent irrigation control method for multi-dimensional parameters of crops based on a neural network. The method acquires parameters such as rainfall, soil moisture, wind speed, temperature and humidity, light intensity, and flow rate of the current irrigated farmland. A crop water demand model with crop water demand signals as response information is established based on the neural network. The multi-dimensional environmental parameters of the crops are calculated and processed by the model. Finally, the water demand of the current farmland crops is predicted. A controller makes a comprehensive judgment result based on the water demand, rainfall, and soil moisture, and controls a solenoid valve according to the judgment result to achieve irrigation for the crops. Although the technical solution considers the factors affecting irrigation water demand comprehensively, the constructed model is very simple, so that the accuracy of water demand prediction results is not high.

In order to solve the above problems, the applicant utilizes the proposed deep neural network for intelligent water precision irrigation control, thus greatly improving the accuracy of water demand prediction.

The creative contribution of the present disclosure lies in:

1. The present disclosure realizes the precise irrigation control for various fruit vegetables in different regions, that is, various fruit vegetables can adopt the same set of control system, thus improving the universality.

2. In order to improve the accuracy of water demand prediction, the present disclosure adopts a new activation function, i.e., a cosine activation function, which is used to train the whole deep neural network, thus greatly improving the training accuracy. This is the first time such a technique has been proposed in the field of irrigation control, and is therefore not a conventional technical approach or common knowledge.

3. In order to improve the prediction accuracy, the present disclosure adopts new algorithms in preprocessing, segmentation, pooling layer, new activation function RI (a parallel implementation solution different from the cosine activation function) and loss function, so as to improve the accuracy and speed of deep neural network training as a whole. This is the first time such a technique has been proposed in the field of irrigation control, and is therefore not a conventional technical approach or common knowledge.

4. In the preprocessing of leaves, considering that most plant leaves are green, for the identified leaves, the G (green) component is enhanced while the R (red) and B (blue) components are relatively suppressed, which helps to improve the accuracy of water demand prediction.

5. The inventor is committed to the research of water demand prediction for precise irrigation of fruit vegetables, and has proposed multiple parallel related solutions. Without causing conflicts, these modules can be cross-combined, and all combinations fall within the scope of the present disclosure.

### SUMMARY OF THE INVENTION

In order to understand the present disclosure more accurately, it is necessary to briefly understand and review the following basic concepts.

The concept of deep learning was put forward by Hinton et al., in 2006. An unsupervised greedy layer-wise training algorithm based on Deep Belief Networks (DBNs) was proposed, bringing hope for solving optimization problems related to deep structures, and subsequently a multi-layer autoencoder deep structure was proposed. In addition, the convolutional neural network proposed by Lecun et al., is the first real multi-layer structure learning algorithm, which uses spatial relative relation to reduce the number of parameters to improve the training performance.

Deep learning is a new field in machine learning research. Its motivation lies in establishing and simulating the neural network of human brain for analysis and learning. It imitates the mechanism of human brain to interpret data, such as images, sounds and texts. Like machine learning methods, deep machine learning methods can also be divided into supervised learning and unsupervised learning. Learning models established under different learning frameworks are quite different. For example, Convolutional neural networks (CNNs) are a machine learning model under deep supervised learning, while Deep Belief Networks (DBNs) are a machine learning model under unsupervised learning.

Convolutional Neural Networks (CNNs) are a type of feed-forward neural networks that incorporate convolutional computation and have a deep structure, serving as one of the representative algorithms of deep learning.

A deep convolutional neural network (DCNN) is a network structure with multiple CNN layers.

The activation functions commonly used in deep neural networks are as follows: sigmoid function, tanh function, ReLU function.

The sigmoid function is a function that maps numbers with values of (∞, +∞) to (0,1). The formula for the sigmoid function is as follows:

$$g ( z ) = \frac{1}{1 + {e}^{- z}}$$

The sigmoid function serves as a nonlinear activation function, but it is not frequently used due to the following disadvantages:

When the value of z is extremely large or extremely small, the derivative g′(z) of the sigmoid function will be close to 0. This will cause the gradient of the weight W to approach zero, so that the gradient update is very slow, that is, the gradient vanishing problem occurs.

The tanh function, which is more common than the sigmoid function, maps numbers with values (−∞, +∞) to (−1, 1). The formula for the tanh function is as follows:

$$g ( z ) = \frac{{e}^{z} - {e}^{- z}}{{e}^{z} + {e}^{- z}} .$$

The tanh function can be considered linear in a short region near 0. Since the mean of the tanh function is 0, the disadvantage of the mean of the sigmoid function being 0.5 is compensated for.

The ReLU function, also known as a rectified linear unit, is a piecewise linear function, which compensates for the vanishing gradient problem of the sigmoid function and the tanh function. The formula for the ReLU function is as follows:

$$g ( z ) = \{ \begin{matrix}z , & if z > 0 \\ 0 , & if z < 0\end{matrix}$$

The advantages of the ReLU function are as follows:

(1) When the input is positive (for most of the input z space), there is no gradient vanishing problem.

(2) The computation speed is much faster. The ReLU function has only a linear relationship, and it is much faster than sigmod and tanh in both forward propagation and backward propagation.

The disadvantages of the ReLU function are as follows:

When the input is negative, the gradient becomes 0, which can lead to the gradient vanishing problem.

On the basis of understanding the above basic concepts and conventional operation modes, the present disclosure provides an intelligent water precise irrigation control system for cultivation of fruit vegetables in solar greenhouses. The system includes:

an information acquisition module, configured to acquire information by means of a plurality of sensors, the acquired information including at least one of soil information, ground environment information, irrigation device use process information, and crop information;

a water demand prediction module, configured to input the acquired information into a trained deep neural network for calculation to predict water demand of fruit vegetables currently cultivated in solar greenhouses; and

an irrigation control module, configured to form a control instruction according to the predicted water demand of fruit vegetables, so as to supply water periodically and quantitatively.

As a specific embodiment, the soil information includes at least one of soil texture, soil field capacity, soil temperature and soil moisture.

As a specific embodiment, the ground environment information includes at least one of current temperature and humidity of the air inside solar greenhouses, the current light intensity at the canopy of fruit vegetables, and cumulative light radiation.

As a specific embodiment, the irrigation device use process information includes at least one of irrigation pipe diameter, flow rate, irrigation duration and irrigation amount.

As a specific embodiment, the crop information includes species of fruit vegetables, growth stage and growth state.

As a specific embodiment, the sensors used in the present disclosure include a soil moisture sensor, a light intensity sensor, an air temperature and humidity sensor and an image sensor.

Further, the present disclosure also provides an intelligent water precise irrigation control method for cultivation of fruit vegetables in solar greenhouses. The method includes:

acquiring, by an information acquisition module, information by means of a plurality of sensors, the acquired information including at least one of soil information, ground environment information, irrigation device use process information, and crop information;

inputting, by a water demand prediction module, the acquired information into a trained deep neural network for calculation to predict water demand of fruit vegetables currently cultivated in solar greenhouses; and

forming, by an irrigation control module, a control instruction according to the predicted water demand of fruit vegetables, so as to supply water periodically and quantitatively.

As a specific embodiment, the soil information includes at least one of soil texture, soil field capacity, soil temperature and soil moisture.

As a specific embodiment, the ground environment information includes at least one of current temperature and humidity of the air inside solar greenhouses, the current light intensity at the canopy of fruit vegetables, and cumulative light radiation.

As a specific embodiment, the irrigation device use process information includes at least one of irrigation pipe diameter, flow rate, irrigation duration and irrigation amount.

As a specific embodiment, the crop information includes species of fruit vegetables, growth stage and growth state.

As a specific embodiment, the sensors used in the present disclosure include a soil moisture sensor, a light intensity sensor, an air temperature and humidity sensor and an image sensor.

The present disclosure also correspondingly provides a computer storage medium storing a program code for implementing any of the methods described above.

The present disclosure also correspondingly provides a computer device, which includes a processor and a memory, wherein the memory stores computer instructions for implementing any of the methods described above.

### BRIEF DESCRIPTION OF DRAWINGS

FIG. 1 is a structural schematic diagram of a basic embodiment of the present disclosure.

### DETAILED DESCRIPTION OF THE INVENTION

In order to make the objectives, technical solutions and advantages of the present disclosure more clear, the present disclosure will be further described in detail below with reference to the accompanying drawings, and it is obvious that the described embodiments are only a part of the embodiments of the present disclosure, but not all of the embodiments. Based on the embodiments in the present disclosure, all other embodiments obtained by a person having ordinary skill in the art without making inventive labor belong to the protection scope of the present disclosure.

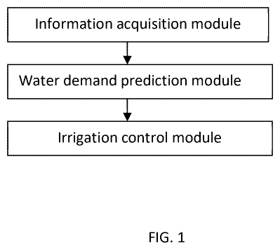

As shown in FIG. 1, the present disclosure provides an intelligent water precise irrigation control system for cultivation of fruit vegetables in solar greenhouses. The system includes:

an information acquisition module, configured to acquire information by means of a plurality of sensors, the acquired information including at least one of soil information, ground environment information, irrigation device use process information, and crop information;

a water demand prediction module, configured to input the acquired information into a trained deep neural network for calculation to predict water demand of fruit vegetables currently cultivated in solar greenhouses; and

an irrigation control module, configured to form a control instruction according to the predicted water demand of fruit vegetables, so as to supply water periodically and quantitatively.

As a specific embodiment, the soil information includes at least one of soil texture, soil field capacity, soil temperature and soil moisture.

As a specific embodiment, the ground environment information includes at least one of current temperature and humidity information of the air inside solar greenhouses, the current light intensity at the canopy of fruit vegetables, and cumulative light radiation.

As a specific embodiment, the irrigation device use process information includes at least one of irrigation pipe diameter, flow rate, irrigation duration and irrigation amount.

As a specific embodiment, the crop information includes species of fruit vegetables, growth stage and growth state.

As a specific embodiment, the sensors used in the present disclosure include a soil moisture sensor, a light intensity sensor, an air temperature and humidity sensor and an image sensor.

The image sensor obtains image information of fruit vegetables, and inputs the obtained image information into a fruit vegetable recognition model to obtain the species of fruit vegetables and the growth stage.

As a specific embodiment, the water demand prediction module obtains the water demand by using a water demand prediction model. The water demand prediction model is a deep convolution neural network (DCNN), which may include an information input layer, one or more convolutional layers, one or more pooling layers, one or more hidden layers and a fully connected layer; the convolutional layer adopts convolutional kernels having a size of 3×3; the pooling layer adopts a maximum pooling method for computation; an activation function adopted by the deep convolutional neural network (DCNN) is a cosine activation function, denoted as f( ) where

$$f ( ) = \frac{1}{N} {\sum }_{i = 1}^{N} \frac{( 1 - {w}_{yi} ) {e}^{cos {θ}_{yi}} + {w}_{yi} {e}^{cos {θ}_{yi}}}{\sqrt{1 - cos {θ}_{yi}^{2}}} ;$$

where θ_{yi} represents the vector angle between a sample i and its corresponding label yᵢ;

N represents the number of training samples; w_{yi} represents the weight of the sample i at its corresponding label yᵢ;

the information input layer receives information from one or more sensors;

the water demand prediction model for fruit vegetables receives output results from the fruit vegetable recognition model, including at least one of the following information: species of fruit vegetables, growth stage and growth state. The fruit vegetable recognition model adopts a VGG-16 network model. Training is conducted using a training set. The training set contains images of over 100 species of fruit vegetables, including cucumber, tomato, chili pepper, eggplant, etc. There are a total of 25,783 images, with 75% used as the training set and 25% as a test set. In order to accelerate the training process, AdamOptimizer is used as an optimizer. The training is implemented using convolutional layers with 64×32 and 32×16 neurons, using 3×3 convolutional kernels respectively, a max pooling layer with a stride of 2, a fully connected layer with 64 neurons, and a softmax regression layer. The optimizer includes at least one of GradientDescentOptimizer, AdagradOptimizer, AdagradDAOptimizer, MomentumOptimizer and RMSPropOptimizer.

Further, optionally, the obtained image information of fruit vegetables is preprocessed. The preprocessing also includes: screening the image information to eliminate images that do not meet the definition requirements or fail to contain at least one complete leaf; the image cropping includes: cropping the obtained image information to obtain leaf information.

Further, optionally, for fruit vegetables with green leaves, the preprocessing further includes: suppressing the R and B components in the RGB color space and enhancing the G channel component.

Further, optionally, to enhance the G component, first, the R, G, and B components of the segmented leaf are separated; an adjustment coefficient for the G component is generated:

$$μ = exp ( 1 + log \sqrt{G ( x , y )} ) ;$$

then, the adjustment coefficient is used for adjustment:

$${G}_{F} = G ( x , y ) * ( 1 + \frac{\sqrt{1 - μ}}{{μ}^{2}} ) ;$$

the adjusted G_{F} is used to inversely synthesize the leaf image;

the decomposition and synthesis of each component belongs to the prior art, but the above adjustment method is pioneered by the inventor. After the above adjustment, the green channel information of the leaf can be fully utilized, so that the subsequent prediction is more accurate.

Further, optionally, the water demand prediction model specifically includes a multi-region convolutional neural network model. The multi-region convolutional neural network model includes: a convolutional network layer, configured to generate mapping features of the original leaf; and a multi-region confidence network model, including confidence network models for multiple regions, and configured to generate multiple different confidence values for different water demand based on the current state of fruit vegetables, fit the different confidence values for the multiple regions to determine a confidence value that is relatively high across different regions, and determine the water demand corresponding to the confidence value as the water demand of fruit vegetables.

Further, optionally, the multi-region confidence network model includes a multi-region pooling layer and a fully connected layer. The multi-region pooling layer includes pooling layers for multiple regions, with the number of the pooling layers being one. The pooling layer can be replaced by the fully connected layer. The pooling layer is used to generate confidence.

Further, optionally, the image segmentation adopts an improved watershed segmentation method:

$$Gra = \frac{{MAX}_{( x , y ∈ D )} ( Gradient ) - {AVG}_{( x , y ∈ D )} ( Gradient )}{{AVG}_{( x , y ∈ D )} ( Gradient ) - {Min}_{( x , y ∈ D )} ( Gradient )} Gradient ( x , y )$$

where Gradient (x, y) represents an original gradient value of a pixel (x,y);

$${AVG}_{( x , y ∈ D )} ( Gradient ) ) , {Min}_{( x , y ∈ D )} ( Gradient ) , and {MAX}_{( x , y ∈ D )} ( Gradient )$$

represent a mean gradient value, a minimum gradient value, and a maximum gradient value within a window region D, respectively; Gra represents a corrected gradient value;

$$S = watershed ( Gra )$$

Further, optionally, the water demand prediction model includes a convolutional network layer and a multi-region confidence network. The convolutional network layer is configured to generate features of each segmented leaf. The multi-region confidence network includes confidence network models for multiple leaf regions and is configured to generate confidence values for different leaf water deficit levels, and take the water deficit at this time as the water demand of fruit vegetables when the confidence values of at least two leaf regions both satisfy a preset first threshold level range.

Further, optionally, as another embodiment, the water demand prediction model includes a convolutional network layer and a multi-region confidence network, wherein the convolutional network layer can receive segmented leaf images of a captured image, and generate convolutional multi-feature mapping of different scales; the multi-region confidence network model includes a multi-region pooling layer and a fully connected layer; wherein the multi-region pooling layer includes pooling layers for multiple regions; the pooling layers for multiple regions are configured to generate confidence values for the water demand of the fruit vegetable images; when the confidence values of at least two leaf regions both satisfy the preset first threshold level range, the water demand at this time is determined as the water demand of fruit vegetables; the multi-region pooling layer is set as the max pooling layer or an average pooling layer; the fully connected layer is configured to classify the recognized leaf water deficit levels.

Optionally, as another embodiment: the water demand prediction model is a deep convolutional neural network, which specifically includes: an input layer, an embedding layer, a pooling layer, and a fully connected layer; the input layer is configured to receive a segmented leaf image of the captured image; the convolutional kernels adopted by the embedding layer have a size of 5×5; the activation function is denoted as R_{I}( ) a water demand prediction recommendation result is further obtained after the processing of the fully connected layer;

the pooling method of the pooling layer is as follows:

$${x}^{e} = f ( 1 - ϕ ( {u}^{e} ) )$$

$${u}^{e} = {w}^{e} ϕ ( {x}^{e - 1} ) ;$$

where, x^{e} represents the output of the current layer, and u^{e} represents the input of the activation function R_{I},

R_{I}( ) represents the activation function, w^{e} represents the weight of the current layer, ϕ represents the loss function, and x^{e-1} represents the output of the previous layer;

the activation function R_{I} is:

$${R}_{l} = {\sum }_{i = 1}^{N} LOG ( \frac{( 1 - {W}_{yi} ) ln ( 1 - s )}{{\sum }_{J} exp ( {W}_{yi} {x}_{i} + {b}_{j} )} )$$

the loss function ϕ is as follows:

$$ϕ = - \frac{1}{N} {\sum }_{i = 1}^{N} ln \frac{{w}_{yi} {e}^{{z}_{i}}}{{\sum }_{j} exp ( {W}_{yi} {x}_{i} + {b}_{j} )}$$

$${Z}_{i} = \frac{{x}_{i} * {w}_{yi}}{‖ {x}_{i} ‖} ;$$

where N represents the size of the positive sample dataset; the value of i ranges from 1 to N; yᵢ represents the label value corresponding to the sample i; w_{yi} represents the weight of the feature vector xᵢ of the sample at its corresponding label yᵢ; s is the recommendation parameter of the deep convolutional neural network; bⱼ represents the deviation of the sample i at its corresponding label yᵢ.

Further, the present disclosure also provides an intelligent water precise irrigation control method for cultivation of fruit vegetables in solar greenhouses. The method includes:

acquiring, by an information acquisition module, information by means of a plurality of sensors, the acquired information including at least one of soil information, ground environment information, irrigation device use process information, and crop information;

inputting, by a water demand prediction module, the acquired information into a trained deep neural network for calculation to predict water demand of fruit vegetables currently cultivated in solar greenhouses; and

forming, by an irrigation control module, a control instruction according to the predicted water demand of fruit vegetables, so as to supply water periodically and quantitatively.

As a specific embodiment, the soil information includes at least one of soil texture, soil field capacity, soil temperature and soil moisture.

As a specific embodiment, the ground environment information includes at least one of current temperature and humidity of the air inside solar greenhouses, the current light intensity at the canopy of fruit vegetables, and cumulative light radiation.

As a specific embodiment, the irrigation device use process information includes at least one of irrigation pipe diameter, flow rate, irrigation duration and irrigation amount.

As a specific embodiment, the crop information includes species of fruit vegetables, growth stage and growth state.

As a specific embodiment, the sensors used in the present disclosure include a soil moisture sensor, a light intensity sensor, an air temperature and humidity sensor and an image sensor.

The image sensor obtains image information of fruit vegetables, and inputs the obtained image information into a fruit vegetable recognition model to obtain the species of fruit vegetables and the growth stage.

As a specific embodiment, the water demand prediction module obtains the water demand by using a water demand prediction model. The water demand prediction model is a deep convolution neural network (DCNN), which includes an information input layer, one or more convolutional layers, one or more pooling layers, one or more hidden layers and a fully connected layer; the convolutional layer adopts convolutional kernels having a size of 3×3; the pooling layer adopts a maximum pooling method for computation; an activation function adopted by the deep convolutional neural network (DCNN) is a cosine activation function, denoted as f( ) where

$$f ( ) = \frac{1}{N} {\sum }_{i = 1}^{N} \frac{( 1 - {w}_{yi} ) {e}^{{cos θ}_{yi}} + {w}_{yi} {e}^{{cos θ}_{yi}}}{\sqrt{1 - cos {θ}_{yi}^{2}}} ;$$

where θ_{yi} represents the vector angle between the sample i and its corresponding label yᵢ; N represents the number of training samples; w_{yi} represents the weight of the sample i at its corresponding label yᵢ.

The information input layer receives information from one or more sensors;

the water demand prediction model for fruit vegetables receives output results from the fruit vegetable recognition model, including at least one of the following information: species of fruit vegetables, growth stage and growth state. The fruit vegetable recognition model adopts a VGG-16 network model. Training is conducted using a training set. The training set contains images of over 100 species of fruit vegetables, including eggplant, tomato cucumber, cabbage, potato, etc. There are a total of 25,783 images, with 75% used as the training set and 25% as a test set. In order to accelerate the training process, an optimizer is used for optimizing. The training is implemented using convolutional layers with 64×32 and 32×16 neurons, using 3×3 convolutional kernels, respectively, a max pooling layer with a stride of 2, a fully connected layer with 64 neurons, and a softmax regression layer. The optimizer includes at least one of GradientDescentOptimizer, AdagradOptimizer, AdagradDAOptimizer, MomentumOptimizer and RMSPropOptimizer.

Further, optionally, the obtained image information of fruit vegetables is preprocessed. The preprocessing also includes: screening the image information to eliminate images that do not meet the definition requirements or fail to contain at least one complete leaf; the image cropping includes: cropping the obtained image information to obtain leaf information.

Further, optionally, for fruit vegetables with green leaves, the preprocessing further includes: suppressing the R and B components in the RGB color space and enhancing the G channel component.

Further, optionally, to enhance the G component, first, the R, G, and B components of the segmented leaf are separated; an adjustment coefficient for the G component is generated:

$$μ = exp ( 1 + log \sqrt{G ( x , y )} ) ;$$

then, the adjustment coefficient is used for adjustment:

$${G}_{F} = G ( x , y ) * ( 1 + \frac{\sqrt{1 - μ}}{{μ}^{2}} ) ;$$

the adjusted G_{F} is used to inversely synthesize the leaf image;

the decomposition and synthesis of each component belongs to the prior art, but the above adjustment method is pioneered by the inventor. After the above adjustment, the green channel information of the leaf can be fully utilized, so that the subsequent prediction is more accurate.

Further, optionally, as a specific embodiment, the water demand prediction model specifically includes a multi-region convolutional neural network model. The multi-region convolutional neural network model includes: a convolutional network layer, configured to generate mapping features of the original leaf; and a multi-region confidence network model, including confidence network models for multiple regions, and configured to generate multiple different confidence values for different water demand based on the current state of fruit vegetables, fit the different confidence values for the multiple regions to determine a confidence value that is relatively high across different regions, and determine the water demand corresponding to the confidence value as the water demand of fruit vegetables.

Further, optionally, the multi-region confidence network model includes a multi-region pooling layer and a fully connected layer. The multi-region pooling layer includes pooling layers for multiple regions, with the number of the pooling layers being one. The pooling layer can be replaced by the fully connected layer. The pooling layer is used to generate confidence.

Further, optionally, the image segmentation adopts an improved watershed segmentation method:

$$Gra = \frac{{MAX}_{( x , y ∈ D )} ( Gradient ) - {AVG}_{( x , y ∈ D )} ( Gradient )}{{AVG}_{( x , y ∈ D )} ( Gradient ) - {Min}_{( x , y ∈ D )} ( Gradient )} Gradient ( x , y )$$

where Gradient (x, y) represents an original gradient value of a pixel (x,y);

$${AVG}_{( x , y ∈ D )} ( Gradient ) ) , {Min}_{( x , y ∈ D )} ( Gradient ) , and {MAX}_{( x , y ∈ D )} ( Gradient )$$

represent a mean gradient value, a minimum gradient value, and a maximum gradient value within a window region D, respectively; Gra represents a corrected gradient value;

$$S = watershed ( Gra )$$

Further, optionally, the water demand prediction model includes a convolutional network layer and a multi-region confidence network. The convolutional network layer is configured to generate features of each segmented leaf. The multi-region confidence network includes confidence network models for multiple leaf regions and is configured to generate confidence values for different leaf water deficit levels, and take the water deficit at this time as the water demand of fruit vegetables when the confidence values of at least two leaf regions both satisfy a preset first threshold level range.

Further, optionally, as another embodiment, the water demand prediction model includes a convolutional network layer and a multi-region confidence network, wherein the convolutional network layer can receive segmented leaf images of a captured image, and generate convolutional multi-feature mapping of different scales; the multi-region confidence network model includes a multi-region pooling layer and a fully connected layer; wherein the multi-region pooling layer includes pooling layers for multiple regions; the pooling layers for multiple regions are configured to generate confidence values for the water demand of the fruit and vegetable images; when the confidence values of at least two leaf regions both satisfy the preset first threshold level range, the water demand at this time is determined as the water demand of fruit vegetables; the multi-region pooling layer is set as the max pooling layer or the average pooling layer; the fully connected layer is configured to classify the recognized leaf water deficit levels.

Optionally, as another embodiment, the water demand prediction model is a deep convolutional neural network, which specifically includes: an input layer, an embedding layer, a pooling layer, and a fully connected layer; the input layer is configured to receive a segmented leaf image of the captured image; the size of the convolutional kernel adopted by the embedding layer is 5×5; the activation function is denoted as Rᵢ( ) a water demand prediction recommendation result is further obtained after the processing of the fully connected layer;

the pooling method of the pooling layer is as follows:

$${x}^{e} = f ( 1 - ϕ ( {u}^{e} ) )$$

$${u}^{e} = {w}^{e} ϕ ( {x}^{e - 1} ) ;$$

where, x^{e} represents the output of the current layer, and u^{e} represents the input of the activation function R_{I},

R_{I}( ) represents the activation function, w^{e} represents the weight of the current layer, ϕ represents the loss function, and x^{e-1} represents the output of the previous layer;

the activation function R_{I} is:

$${R}_{l} = {\sum }_{i = 1}^{N} LOG ( \frac{( 1 - {W}_{yi} ) ln ( 1 - s )}{{\sum }_{j} exp ( {W}_{yi} {x}_{i} + {b}_{j} )} )$$

the loss function ϕ is as follows:

$$ϕ = - \frac{1}{N} {\sum }_{i = 1}^{N} ln \frac{{w}_{yi} {e}^{{z}_{i}}}{{\sum }_{j} exp ( {W}_{yi} {x}_{i} + {b}_{j} )}$$

$${Z}_{i} = \frac{{x}_{i} * {w}_{yi}}{‖ {x}_{i} ‖} ;$$

where N represents the size of the positive sample dataset; the value of i ranges from 1 to N; yᵢ represents the label value corresponding to the sample i; w_{yi} represents the weight of the feature vector x; of the sample at its corresponding label yᵢ; s is the recommendation parameter of the deep convolutional neural network; bⱼ represents the deviation of the sample i at its corresponding label yᵢ.

In the description of this description, descriptions referring to the terms “one embodiment”, “example” and “specific example” mean that specific features, structures, materials or characteristics described in connection with this embodiment or example are included in at least one embodiment or example of the present disclosure. In this description, schematic expressions of the above terms do not necessarily refer to the same embodiment or example.

The present disclosure also provides a computer-readable medium, which contains a program code for implementing the system described above. The contained program code may be transmitted over any appropriate medium, including but not limited to wireless, electric wires, optical cables, RF, etc., or any suitable combination of the above. The computer-readable medium may be a computer-readable signal medium or a computer-readable storage medium. The computer-readable storage medium may be, for example, an electrical, magnetic, optical, electromagnetic, infrared, or semiconductor system, apparatus, or device, or a combination of any of the above. More specific examples (a non-exhaustive list) of the computer-readable storage medium include: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any of the above. In this document, the computer-readable storage medium may be any tangible medium containing or storing a program, which can be used by or in combination with an instruction execution system, apparatus or device. Computer program codes for performing the operations of the present disclosure may be written in one or more programming languages or their combinations, including object-oriented programming languages such as Java, Smalltalk, C++, and conventional procedural programming languages such as the “C” language or similar programming languages. The program codes may be executed entirely on a user computer, in part on the user computer, as a separate software package, in part on the user computer and in part on a remote computer, or entirely on a remote computer or a server. In the scenario involving a remote computer, the remote computer may be connected to the user computer through any type of network, including a local area network (LAN) or a wide area network (WAN), or the connection may be made to an external computer (for example, through the Internet using an Internet Service Provider). The integrated units described above, implemented in the form of software functional units, may be stored in the computer-readable storage medium. The software functional units are stored in a storage medium and include instructions for causing a computer device (which may be a personal computer, a server, a network device, or the like) or a processor to perform some of the steps of the method according to the various embodiments of the present disclosure. The aforementioned storage medium includes various media in which program codes can be stored, such as a compact disk, a removable hard disk, a read-only memory (ROM), a random access memory (RAM), a magnetic disk, or an optical disk.

The above is only the preferred embodiments of the present disclosure, and is not intended to limit the patent scope of the present disclosure. Any equivalent structure or equivalent process transformation made by using the contents of the description and drawings of the present disclosure, or directly or indirectly applied to other related technical fields, are equally included in the patent protection scope of the present disclosure. The preferred embodiments of the present disclosure disclosed above are intended only to help illustrate the present disclosure. It is not intended to elaborate all details of the preferred embodiments, nor is it intended to limit the present disclosure only to the specific embodiments described. Obviously, many modifications and changes can be made according to the contents of this description. These embodiments are selected and described in detail in this description in order to better explain the principle and practical application of the present disclosure, so that those skilled in the technical field can better understand and utilize the present disclosure. The present disclosure is limited only by the claims and their full scope and equivalents.

1. An intelligent water precise irrigation control system for cultivation of fruit vegetables in solar greenhouses, comprising:
an information acquisition module, configured to acquire information by means of a plurality of sensors, the acquired information comprising at least one of soil information, ground environment information, irrigation device use process information, and crop information;
a water demand prediction module, configured to input the acquired information into a trained deep neural network for calculation to predict water demand of fruit vegetables currently cultivated in solar greenhouses; and
an irrigation control module, configured to form a control instruction according to the predicted water demand of fruit vegetables, so as to supply water periodically and quantitatively; wherein
the water demand prediction module obtains water demand by using a water demand prediction model; the water demand prediction model is a deep convolution neural network (DCNN), which may comprise an information input layer, one or more convolutional layers, one or more pooling layers, one or more hidden layers and a fully connected layer; the convolutional layer adopts convolutional kernels having a size of 3×3; the pooling layer adopts a maximum pooling method for computation; an activation function adopted by the deep convolutional neural network (DCNN) is a cosine activation function, denoted as f( ) where
$$f ( ) = \frac{1}{N} {\sum }_{i = 1}^{N} \frac{( 1 - {w}_{yi} ) {e}^{{cos θ}_{yi}} + {w}_{yi} {e}^{{cos θ}_{yi}}}{\sqrt{1 - cos {θ}_{yi}^{2}}} ;$$
where θ_{yi} represents a vector angle between a sample i and a corresponding label yᵢ; N represents the number of training samples; w_{yi} represents a weight of the sample i at the corresponding label yᵢ;
for fruit vegetables with green leaves, preprocessing further comprises: suppressing R and B components in an RGB color space and enhancing a G channel component;
first, the R, G, and B components of a segmented leaf are separated; an adjustment coefficient for the G component is generated: μ=exp (1+log{square root over (G(x,y)))};
then, the adjustment coefficient is used for adjustment:
$${G}_{F} = G ( x , y ) * ( 1 + \frac{\sqrt{1 - μ}}{{μ}^{2}} ) ;$$
the adjusted G_{F} is configured to inversely synthesize a leaf image.

2. The control system according to claim 1, wherein the soil information comprises at least one of soil texture, soil field capacity, soil temperature and soil moisture.

3. The control system according to claim 1, wherein the ground environment information comprises at least one of current temperature and humidity of air inside solar greenhouses, a current light intensity at the canopy of fruit vegetables, and cumulative light radiation.

4. The control system according to claim 1, wherein the irrigation device use process information comprises at least one of irrigation pipe diameter, flow rate, irrigation duration and irrigation amount.

5. The control system according to claim 1, wherein the crop information comprises species of fruit vegetables, growth stage and growth state.

6. An intelligent water precise irrigation control method for cultivation of fruit vegetables in solar greenhouses, comprising:
acquiring, by an information acquisition module, information by means of a plurality of sensors, the acquired information comprising at least one of soil information, ground environment information, irrigation device use process information, and crop information;
inputting, by a water demand prediction module, the acquired information into a trained deep neural network for calculation to predict water demand of fruit vegetables currently cultivated in solar greenhouses; and
forming, by an irrigation control module, a control instruction according to the predicted water demand of fruit vegetables, so as to supply water periodically and quantitatively, wherein
the water demand prediction model specifically comprises a multi-region convolutional neural network model; the multi-region convolutional neural network model comprises: a convolutional network layer, configured to generate mapping features of an original leaf; and a multi-region confidence network model, comprising confidence network models for multiple regions, and configured to generate multiple different confidence values for different water
demand based on a current state of fruit vegetables, fit the different confidence values for the multiple regions to determine a confidence value that is relatively high across different regions, and determine the water demand corresponding to the confidence value as the water demand of fruit vegetables;
the multi-region confidence network model comprises a multi-region pooling layer and a fully connected layer; the multi-region pooling layer comprises pooling layers for multiple regions, with the number of the pooling layers being one; the pooling layer is configured to generate confidence;
image segmentation adopts an improved watershed segmentation method:
$$Gra = \frac{{MAX}_{( x , y ∈ D )} ( Gradient ) - {AVG}_{( x , y ∈ D )} ( Gradient )}{{AVG}_{( x , y ∈ D )} ( Gradient ) - {Min}_{( x , y ∈ D )} ( Gradient )} Gradient ( x , y )$$
where Gradient (x, y) represents an original gradient value of a pixel (x,y);
$${AVG}_{( x , y ∈ D )} ( Gradient ) ) , {Min}_{( x , y ∈ D )} ( Gradient ) , and {MAX}_{( x , y ∈ D )} ( Gradient )$$
represent a mean gradient value, a minimum gradient value, and a maximum gradient value within a window region D, respectively; Gra represents a corrected gradient value;
$$S = watershed ( Gra ) ,$$
where S represents a final segmentation result.

7. The control method according to claim 6, wherein the soil information comprises at least one of soil texture, soil field capacity, soil temperature and soil moisture.

8. The control method according to claim 6, wherein the ground environment information comprises at least one of current temperature and humidity of air inside solar greenhouses, a current light intensity at the canopy of fruit vegetables, and cumulative light radiation.

9. The control method according to claim 6, wherein the irrigation device use process information comprises at least one of irrigation pipe diameter, flow rate, irrigation duration and irrigation amount.

10. The control method according to claim 6, wherein the crop information comprises species of fruit vegetables, growth stage and growth state.
